(19) United States
(12) Patent Application Publication
(10) Pub. No.: US 2007/0212537 A1
(43) Pub. Date: Sep. 13, 2007

(54) Method and device for producing a fluid-tight connection of layers of material and corresponding sealing

(76) Inventors: Thomas Seeger, Niederstotzingen (DE); Dirk Haensch, Aachen (DE)

Correspondence Address: MELVIN K. SILVERMAN, 500 WEST CYPRESS CREEK ROAD, SUITE 500, FT. LAUDERDALE, FL, 33309, US

(21) Appl. No.: 11/801,639

(22) Filed: May 10, 2007

Related U.S. Application Data
(62) Division of application No. 10/855,019, filed on May 27, 2004.
Application No. 10/855,019 is a continuation-in-part of application No. PCT/EP02/13272, filed on Nov. 26, 2002.

(30) Foreign Application Priority Data
Nov. 27, 2001 (DE) 10158016.9

(51) Int. Cl. B32B 5/02

(52) U.S. Cl. 428/354

(57) ABSTRACT

In the case of a method for producing a liquid-tight connection between layers of material, in particular textile fabrics, an adhesive layer of an additional sealing strip that seals the layers of material is melted by means of a laser bean. After that, the sealing strip is connected to the layers of material. A relative movement takes place between the laser beam and the sealing strip.

### CROSS REFERENCE TO RELATED APPLICATION

This application is a divisional application of patent application Ser. No. 10/855,019, filed on May 27, 2004, which is a Continuation-in-part of PCT Application No. PCT/EP02/13272, filed on Nov. 26, 2002, which claims priority of German patent application No. 101 58 016.0, filed on Nov. 27, 2001. All parent applications are herein incorporated by reference in their entirety.

### FIELD OF THE INVENTION

The invention relates to a method for producing a liquid-tight connection between layers of material, in particular textile fabrics. Furthermore, the invention relates to a sealing strip for sealing two layers of material connected to one another.

### BACKGROUND OF THE INVENTION

In the case of a method described in WO 01/81082A1, two layers of material are connected to one another by heating of the same, with thermal radiation or hot air being used. Among possible techniques is that of using a laser for evaporating solvent or for removing a silicone release layer. The laser consequently merely represents an auxiliary means for preparing a joint to be produced later. Among other things, two textile layers are connected with the aid of a sealing strip, but it is not specified how this connection is to take place.

In the method described in EP 0 126 787 A1, two layers of film-like material of plastic in web form are connected to one another. In this case, various particles, including carbon black particles, may be incorporated in the film. However, the TiO.sub.2, proposed inter alia, can only be used as a reflector, not as an absorber. A CO₂ laser used in the case of this method is accompanied by the problem that it can only penetrate deep enough into the material in the case of certain materials, for example the materials PE and PP used there. Furthermore, in the case of this solution it is attempted to change the depth of penetration of the laser beam with the aid of optical devices, but this is not possible According to the Lambert-Beer law. A contactlessly operating temperature sensor provided for this purpose is arranged after the location of the joint and is intended to regulate the energy introduced into the films. However, no influence on the melting of the adhesive layer can be brought to bear in this way.

The method described in U.S. Pat. No. 4,029,535 is similar to that of EP 0 126 787 A1, but is used for synthetic textiles. In this case, a pulsed laser is used for achieving very high amounts of energy and selective melting, but is very difficult to control.

In the case of DE 199 54 440 A1, a connecting strip of laser-absorbing plastic is used, the plastic material of which is melted to achieve a connection between two ends of a plastic body. The method used there is transmission laser welding, in which both components to be connected are melted, which, however, when using textiles, would lead to the same being melted and consequently destroyed. A further problem is the great restriction on the selection of colors of the plastics, to allow the method described to be carried out.

In the case of the method described in JP 04-102580, an adhesive layer is provided, connecting a steel plate to two separate layers of resin. An additional, single-layer strip is then intended to connect the two layers of resin to one another. A laser that is used in this case is directed by the so-called transmission method from above onto the strip arranged over the layers of resin and is absorbed in a volume absorption in two layers, which on account of the depth of penetration of the laser beam leads to the melting of these two layers.

According to WO 01/43949 A1, films of plastic are welded directly to one another, with energy being supplied by a laser.

In the case of the method known from U.S. Pat. No. 3,574,031, thermoplastic materials are welded to one another, for which purpose carbon black particles are arranged in an adhesive layer. However, this method cannot ensure water tightness of the connection.

In U.S. Pat. No. 5,792,301, two layers of coated paperboard are welded to one another directly by means of a CO.sub.2 laser beam. In this case, beam shaping is provided, transforming a point into a line.

FR 1,500,197 describes a method in which films of plastic are heated. A special laser is used, with for the most part superficial absorption, as a result of which uniform melting of the adhesive layer cannot be achieved.

In the case of the method described in GB 2 046 171 A, a sealing strip is connected to a textile material by seams which consist of room temperature vulcanizing silicone. The use of a laser is not required in this case.

DE 35 40 366 C1 describes a method for producing a durable, liquid-tight connection between layers of material, the edges of which are enclosed by a binding strip to be folded in a U shape, sewn together and welded or adhesively bonded. However, the binding strip used there is of a relatively complicated construction and therefore both complex to produce and difficult to handle.

DE 197 39 592 A1 discloses a liquid-tight, linear seam for single- or multi-layered textile fabrics. Provided in this case is a high-frequency reactive polymer film strip which is penetrated by sewing threads, the stitching holes being filled and sealed by a portion of the film strip that runs under exposure to heat.

With respect to further methods for producing such liquid-tight connections, reference is made to EP 0 791 674 A1, JP 09084980 A or JP 08243273 A. In these cases it is usually attempted to seal the penetration holes created during the production of a seam, to some extent already during the sewing.

WO 90/05069 A1 discloses a further method in which a sealing strip is applied to two layers of material already sewn together, for which purpose an adhesive layer of the sealing strip is heated by means of hot air that is under pressure and is supplied by a blower or the like.

However, this method has a great number of disadvantages, which on the one hand arise due to the fact that the temperature produced by means of the hot air of several hundred .degree. C. in the region of the adhesive layer cannot be accurately measured, and therefore cannot always be correctly set, so that it is very difficult to make statements about the quality of the sealing connection. This usually has the effect that an excessive temperature is produced, which results in further disadvantages, such as the burning of oil, necessary for generating pressure, contained in the air and of other contaminants, and the resultant development of smoke, which brings with it adverse effects on the health of the operators, increased temperatures at the workplace and increased energy consumption.

In principle, the hot, pressurized air that is used, or the elements required for this such as blowers and compressors, also generate a very high level of noise and lead to the inclusion of air bubbles in the adhesive layer of the sealing strip, as a result of which the integrity of the seal of the connection cannot be ensured, in particular when it is later used in textiles.

Usually, a nozzle is provided to deliver the hot air, the position of which has a decisive influence on the quality of the connection, since the temperature of the hot air decreases very significantly after it leaves the nozzle. The continued use of the nozzle/heating unit keeps giving rise to changes in the nozzle position, which continually changes the quality of the connection.

### SUMMARY OF THE INVENTION

It is therefore an object of the present invention to provide a method and an apparatus for producing a liquid-tight connection between layers of material which ensures process reliability in the sense of high production accuracy and an associated reliable integrity of the seal of the connection. A further aim of the invention is to provide a sealing strip for sealing two layers of material connected to one another which is suitable for use in the method and permits great integrity of the seal of the layers of material connected to one another.

This object is achieved according to the invention by the features described hereinafter.

The laser beam used according to the invention, which melts the adhesive layer of the sealing strip or the adhesive layer of the one layer of material, produces a great number of advantages, to be precise both as far as the actual method is concerned and as far as the product thereby produced is concerned.

The laser beam makes it possible, by introducing a quite specific amount of energy, to set a very exact temperature at that position of the sealing strip or the layer of material at which the melting of the adhesive layer is intended to take place, so that virtually no differences in temperature occur any longer. This uniform temperature allows best possible melting characteristics of the adhesive layer to be set, which leads to optimum connection of the sealing strip to the layers of material or of the layers of material to one another.

It is consequently no longer necessary to set an excessive temperature in the region of the adhesive layer to achieve a secure adhesive bond. Rather, by dispensing with pressurized hot air and using the laser beam for melting the adhesive layer, very much lower temperatures are obtained in the working area, and as a result more pleasant working conditions if the layers of material and possibly the sealing strip are fed in manually. On account of these better working conditions, greater accuracy in manual working, and consequently better integrity of the seal of the connection, are of course also to be expected.

Since the light energy of a laser beam decreases only slightly with the distance from the laser source, such a laser source may be arranged at virtually any desired distance from the actual location to be heated or adhesively bonded, which advantageously leads to considerably increased flexibility in production.

The introduction of light energy into the adhesive layer for melting the same advantageously does not lead to air bubbles, as a result the integrity of the seal of the connection is obtained. At the same time a higher rate of advancement, better handling and consequently greater production reliability with reproducible results are achieved. The accuracy of the connection produced by the method according to the invention is ensured by the pinpoint accuracy of the melting of the adhesive layer with the laser beam.

A simple possibility for controlling the method according to the invention can be obtained if, in an advantageous development of the invention, the energy of the laser beam is controlled in dependence on the melting of the adhesive layer.

A sealing strip for sealing two layers of material that are connected, in particular sewn, to one another is described hereinafter.

According to the invention, this sealing strip has along with the at least one sealing layer and the at least one adhesive layer light-absorbing particles which convert the light energy generated by the laser beam and introduced into the sealing strip at least in large part into thermal energy, and in this way melt the adhesive layer.

It has proven to be particularly advantageous for converting the energy of the laser source into thermal energy for melting the adhesive layer if the light-absorbing particles are formed by carbon black particles.

In order in particular in the case of high-value textile fabrics also to obtain correspondingly high-value products, it may be provided in an advantageous refinement of the sealing strip that a textile layer is provided on the side opposite from the adhesive layer.

### BRIEF DESCRIPTION OF DRAWINGS

Further advantageous refinements and development of the invention emerge from the claims and from the exemplary embodiments represented in principle below on the basis of the drawing, in which:

FIG. 1 shows a first embodiment of an apparatus for carrying out the method according to the invention;

FIG. 2 shows a second embodiment of an apparatus for carrying out the method according to the invention;

FIG. 3 shows a liquid-tight connection produced by means of the method according to the invention in a first embodiment;

FIG. 4 shows a liquid-tight connection produced by means of the method according to the invention in a second embodiment; and

FIG. 5 shows a sealing strip according to the invention.

### DETAILED DESCRIPTION OF THE INVENTION

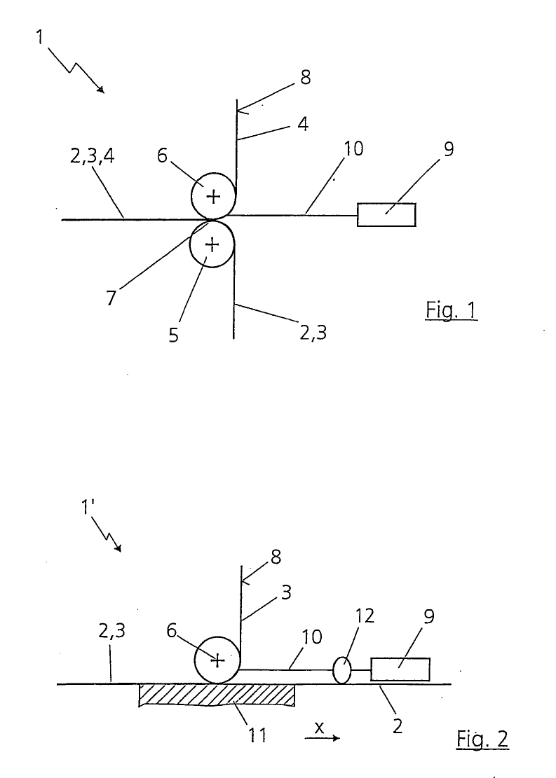

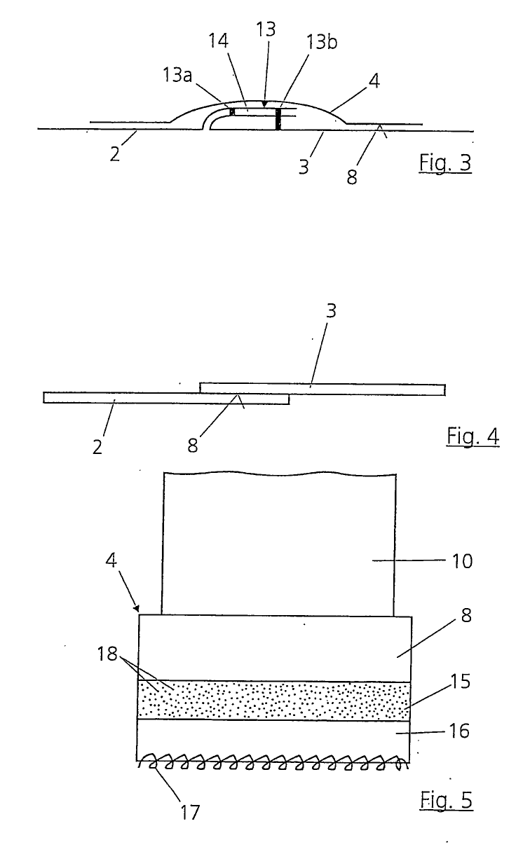

FIG. 1 shows an apparatus 1 for sealing a seam (which cannot be seen here), which connects two layers of material 2 and 3, preferably textile fabrics, to one another. Provided for the sealing is a sealing strip 4, the structure of which is described in more detail later with reference to FIG. 5. The connection of the layers of material 2 and 3 produced with the sealing strip 4 by means of the apparatus 1 and the method described below is represented in more detail in FIG. 3.

The apparatus 1 has two rollers 5 and 6, which are both set in rotation by means of respective drive devices (not represented), for example an electric motor. The first roller 5, rotating counterclockwise, is provided for transporting the sewn-together layers of material 2 and 3, whereas the second roller 6, rotating clockwise, transports the sealing strip 4. Between the two rollers 5 and 6 there is a roller nip 7, in which the sealing strip 4 is pressed with the layers of material 2 and 3 in such a way that the connection represented in FIG. 3 is obtained. The force necessary for this can be applied for example by pneumatic or hydraulic cylinders (not represented), which act on the rollers 5 and 6.

The sealing strip 4 is provided on its side facing the layers of material 2 and 3, that is to say facing away from the roller 6, with an adhesive layer 8, which is melted by means of a laser beam 10 generated by a laser source 9. A laser source 9 emitting radiation in the IR range may be used for example as the laser source 9.

At the same time, a relative movement takes place between the sewn-together layers of material 2 and 3 and the sealing strip 4 on the one hand, which are of course transported, as described above, by means of the rollers 5 and 6, and the stationary laser beam 10 on the other hand. This has the result that it is only ever a region of the sealing strip 4 that is melted, which region is adhesively bonded directly thereafter to the layers of material 2 and 3, as described below. In many applications the layers of material 2 and 3 are manually fed in and aligned such that a sound connection is obtained. In this respect it is also possible to move the layers of material 2 and 3 on curved paths. However, a controlled movement is also possible, with the sealing strip 4 always remaining in a fixed position.

The laser beam 10 may be introduced with a fixed amount of energy into the sealing strip 4, so that a fixed, usually relatively low, temperature prevails there, just enough to melt the adhesive layer 8 in the way desired. A measurement (not represented) of the radiation back from the adhesive layer 8 allows the supply of energy from the laser source 9, that is to say the energy content of the laser beam 10, to be controlled, so that there is always optimum melting of the adhesive layer 8.

After the melting of the adhesive layer 8, the sealing strip 4 is transported further by the roller 6 in the direction of the roller nip 7 and the sealing strip 4 is adhesively attached to the layers of material 2 and 3 by the pressure of the rollers 5 and 6. It goes without saying that the melting of the adhesive layer 8 and the subsequent adhesive bonding proceed in a continuous process, in which for example the rotational speed of the two rollers 5 and 6 can be controlled.

In order to adhesively bond two layers of material 2 and 3 that have not previously being sewn together in a similar manner described above, a further apparatus 1′ is represented in FIG. 2. In the present case, the layer of material 2 rests on a firm support 11 and the roller 6 is moved together with the laser source 9 in the direction of the arrow X. In this case, the second layer of material 3 is provided with the adhesive layer 8, which in turn is melted by the laser beam 10, and is fed with the aid of the roller 6 from above, as also in the case of the apparatus 1, in which respect different feeding could also be conceivable.

To permit simple control of the movements required, the roller 6 may for example be mechanically connected to the laser source 9. In order to deflect the laser beam 10, or adapt the same to the width of the adhesive layer 8, or in order to perform any other desired changes to the laser beam 10, an optical device 12 is connected upstream of the laser source 9, which may be of a type known per se. An optical device may also be provided in the case of the apparatus 1 according to FIG. 1.

The two apparatuses 1 and 1′ described with reference to FIG. 1 and FIG. 2 are to be regarded in their actual configuration as merely given by way of example. Further devices could also be provided, for example to position or move the layers of material 2 and 3 or the sealing strip 4. Furthermore, it would also be possible with the apparatus 1 represented in FIG. 1, with the two rollers 5 and 6, to connect the two layers of material 2 and 3 to one another without the sealing strip 4, and conversely it could also be conceivable with the apparatus 1′ represented in FIG. 2, with the roller 6 and the support 11, to apply the sealing strip 4 to the already previously sewn-together layers of material 2 and 3.

FIG. 3 shows the connection of the sealing strip 4 to the layers of material 2 and 3 produced in the present case by the apparatus 1. In this case, the layers of material 2 and 3 were connected before the adhesive attachment of the sealing strip 4 by means of a seam 13, which in the present case also comprises two individual seams 13a and 13b. In a way known per se, firstly the layer of material 2 was thereby connected to the layer of material 3 by the first seam 13a; whereupon the flap 14 produced as a result was sewn in this case to the layer of material 3 by a further seam 13b. It goes without saying that it is also possible to connect the layers of material 2 and 3 to one another before the sealing simply by a single seam or, if appropriate, in a completely different way.

The sealing strip 4 seals the seam 13 in a liquid-tight manner. In particular when textile fabrics are used, and in that case especially in the production of garments, such as for example waterproof suits, the sealing strip 4 is arranged on an inner side of the garment, so that a sealing of the seam 13 is obtained as a result and no liquid can reach a person wearing the garment from the outside. Theoretically, the sealing strip 4 can also be attached to an outer side of the garment.

The connection between the two layers of material 2 and 3 produced by means of the apparatus 1′ represented in FIG. 2 is represented in FIG. 4. This connection is of a very much simpler structure and merely comprises the layer of material 2 and the layer of material 3, with the adhesive layer 8, as already mentioned, being located on part of the layer of material 3. One area of use of the connection represented in FIG. 4 may be, for example, when two films of a large surface area are to be adhesively bonded to one another in a liquid-tight manner.

FIG. 5 shows a section through the sealing strip 4, which apart from the adhesive layer 8 already described above has a first sealing layer 15, a second sealing layer 16 and also a fabric or textile layer 17 opposite from the adhesive layer 8. Arranged within the first sealing layer 15, consisting for example of a thermosetting material or a high-melting thermoplastic, are light-energy-absorbing or light-absorbing pigments or particles 18, such as for example carbon black particles, which convert the light energy penetrated into the sealing strip 4 into thermal energy and in this way provide melting of the adhesive layer 8. The fact that the light-absorbing particles 18 are not contained in the adhesive layer 8 means that the adhesive properties of the same are not adversely affected. It goes without saying that other substances or materials may also be used as light-absorbing particles 18.

The adhesive layer 8 is of a transparent form, in order to prevent loss of energy introduced into the sealing strip 4 by the laser beam 10. In this case, the coloration of the adhesive layer 8 is independent of its transparency. If appropriate, just one of the sealing layers 15 and 16 could also be provided and the light-absorbing particles 18 could also be arranged in a completely independent layer at any desired location within the sealing strip 4.

The textile layer 17, which may take the form of knitwear, wovens or nonwovens, is inserted in the second sealing layer 16 during the production of the same, which in the present case likewise comprises a thermosetting material or a high-melting thermoplastic, so that a solid connection of the second sealing layer 16 to the textile layer 17 takes place. The textile layer 17 ensures that, when the sealing strip 4 is used for garments, a uniform quality is ensured on the inner side of the same, for which purpose the textile layer 17 may for example be of the same color and the same material as the respective garment. If, in very simple applications, the textile layer 17 is omitted, one of the sealing layers 15 or 16 may also be of a corresponding color.

The adhesive layer 8 may consist of a polymer, such as for example a thermoplastic, such as polyurethane, polypropylene, polystyrene or the like, in which case the energy content of the laser beam 10 should be made to match the material of the adhesive layer 8, so that optimum melting of the same can be ensured. This means that, in the case of different materials of the adhesive layer 8, if appropriate different types of laser sources may also be provided, or different activation of the laser source 9, for example with respect to its power.

What is claimed is:

1. A sealing strip comprising an adhesive layer, at least one sealing layer, and light-absorbing particles.

2. The sealing strip of claim 1, wherein said light-absorbing particles are comprised within said at least one sealing layer.

3. The sealing strip of claim 1, wherein said light-absorbing particles are comprised in a layer separate from said adhesive layer and said at least one sealing layer.

4. The sealing strip of claim 1, wherein said light-absorbing particles comprise carbon black particles.

5. The sealing strip of claim 1, wherein said at least one sealing layer comprises a thermosetting material.

6. The sealing strip of claim 1, wherein said adhesive layer is transparent.

7. The sealing strip of claim 1, wherein said adhesive layer comprises a polymer comprising polyurethane, polypropylene, or polystyrene.

8. The sealing strip of claim 1, wherein when exposed to a laser beam, said light-absorbing particles enable converting light energy received from said laser beam to heat, and causing said adhesive layer to melt.

9. The sealing strip of claim 1 further comprising a textile layer next to said at least one sealing layer opposite of said adhesive layer.

10. The sealing strip of claim 1 further comprising a second sealing layer next to said at least one sealing layer opposite of said adhesive layer.

11. The sealing strip of claim 10, wherein said light-absorbing particles are comprised within said at least one sealing layer.

12. The sealing strip of claim 10, wherein said second sealing layer comprises a thermosetting material.

13. The sealing strip of claim 10, wherein said second sealing layer comprises therein a textile layer.

14. A sealing strip comprising an adhesive layer, a first sealing layer next to said adhesive layer, and a second sealing layer next to said first sealing layer opposite of said adhesive layer, said first sealing layer comprising therein light-absorbing particles.

15. The sealing strip of claim 14, wherein said light-absorbing particles comprise carbon black particles.

16. The sealing strip of claim 14, wherein said adhesive layer is transparent.

17. The sealing strip of claim 14, wherein said adhesive layer comprises a polymer comprising polyurethane, polypropylene, or polystyrene.

18. The sealing strip of claim 14, wherein said first and said second sealing layers comprise a thermosetting material.

19. The sealing strip of claim 14, wherein said second sealing layer comprises therein a textile layer.

20. The sealing strip of claim 14, wherein when exposed to a laser beam, said light-absorbing particles in said first sealing layer enable converting light energy received from said laser beam to heat, and causing said adhesive layer to melt.
